(19) United States
(12) Patent Application Publication
(10) Pub. No.: US 2019/0311290 A1
(43) Pub. Date: Oct. 10, 2019

(54) Deep Learning Based Test Compression Analyzer

(71) Applicant: Mentor Graphics Corporation, Wilsonville, OR (US)

(72) Inventors: Yu Huang, West Linn, OR (US); Wu-Tung Cheng, Lake Oswego, OR (US); Gaurav Veda, Hillsboro, OR (US); Janusz Rajski, West Linn, OR (US)

(21) Appl. No.: 16/376,315

(22) Filed: Apr. 5, 2019

Related U.S. Application Data
(60) Provisional application No. 62/653,655, filed on Apr. 6, 2018.

(51) Int. Cl. G06N 20/00

(52) U.S. Cl. CPC G06N 20/00

(57) ABSTRACT

One or more machine-learning models are trained and employed to predict test coverage and test data volume. Input features for the one or more machine-learning models comprise the test configuration features and the design complexity features. The training data are prepared by performing test pattern generation and circuit design analysis. The design complexity features may comprise testability, X-profiling, clock domains, power domains, design-rule-checking warnings, or any combination thereof.

### RELATED APPLICATIONS

This application claims the benefit of U.S. Provisional Patent Application No. 62/653,655, filed on Apr. 6, 2018, titled “Deep Learning Based Test Compression Analyzer,” and naming Yu Huang et al. as inventors, which application is incorporated entirely herein by reference.

### FIELD OF THE DISCLOSED TECHNIQUES

The presently disclosed techniques relates to circuit testing. Various implementations of the disclosed techniques may be particularly useful for determining test circuitry configuration.

### BACKGROUND OF THE DISCLOSED TECHNIQUES

Design complexity keeps increasing. A design often can have over 1 gillion gates, 100 million scan cells, and/or hundreds of cores. New technology such as fin field effect transistor (FinFET) and extreme ultraviolet lithography requires new fault models and thus more test patterns for circuit testing. To reduce test costs, various on-chip compression schemes have been developed. In these schemes, a tester delivers compressed test patterns by using a small number of inputs (called input channels) while an on-chip decompressor expands them into data to be loaded into a large number of scan chains. A compactor is used to compact test responses shifted out from the internal scan chains to a small number of outputs (called output channels). The test encoding methods typically take advantage of low test pattern fill rates.

Although test compression techniques can significantly reduce the test cost, they may also complicate the design-for-test (DFT) planning by introducing more parameters. Not only the number of scan chains to be inserted into a design needs to be carefully decided, but the selection of the numbers of input/output channels can also have an impact on test coverage and test data volume. A conventional test compress analyzer employs a brute force “trial-and-error” method. First, users provide multiple sets of parameters. The conventional test compress analyzer emulates the design by changing test configurations based on each of the sets of parameters. Test pattern generation is run to obtain accurate test coverage and pattern count, power metrics, etc. Then users can either select the best configuration based on these emulation runs or continue searching for new configurations until they are satisfied. This flow is time-consuming because test pattern generation is slow for large circuits. A way to tradeoff could be running test pattern generation with fault sampling, but this compromises analytical accuracy.

### BRIEF SUMMARY OF THE DISCLOSED TECHNIQUES

Various aspects of the disclosed technology relate to machine-learning-based test coverage and data volume prediction for determining test configuration. In one aspect, there is a method, executed by at least one processor of a computer, comprising: receiving a plurality of circuit designs and a plurality sets of values of test configuration features for each of the plurality of circuit designs, the test configuration features comprising numbers for scan chains, input channels for decompressors and output channels for compactors, respectively; performing test pattern generation to determine values of test coverage and values of test data volume for each of the plurality sets of values of the test configuration features for each of the plurality of circuit designs; analyzing the plurality of circuit designs to determine values of design complexity features for each of the plurality of circuit designs; training one or more machine-learning models based on the plurality sets of test configuration feature values, the values of design complexity features, the values of test coverage, and the values of test data volume, wherein input features for the one or more machine-learning models comprise the test configuration features and the design complexity features, and wherein output features for the one or more machine-learning models comprise the test coverage and the test data volume; and storing the one or more machine-learning models.

The method may further comprise: using the one or more machine-learning models to predict values of the test coverage and values of the test data volume for a plurality sets of values of the test configuration features for a new circuit design; and determining optimal values of the test configuration features for the new circuit design. The method may further still comprise: inserting test circuitry into the new circuit design based on the optimal values of the test configuration features.

The input features for the one or more machine-learning models may further comprise: one or more general design features. The one or more general design features may comprise a number of gates, a number of faults, a number of primary inputs, a number of primary outputs, or any combination thereof

The one or more machine-learning models may comprise a first machine-learning model and a second machine-learning model. The input features for the first machine-learning model and the input features for the second machine-learning model are the same, the output feature for the first machine-learning model is the test coverage, and the output feature for the second machine-learning model is the test data volume.

The decompressors may be EDT-based. The one or more machine-learning models may be Artificial Neural Networks. The design complexity features may comprise testability, X-profiling, clock domains, power domains, design-rule-checking warnings, or any combination thereof.

In another aspect, there are one or more non-transitory computer-readable media storing computer-executable instructions for causing one or more processors to perform the above method.

Certain inventive aspects are set out in the accompanying independent and dependent claims. Features from the dependent claims may be combined with features of the independent claims and with features of other dependent claims as appropriate and not merely as explicitly set out in the claims.

Certain objects and advantages of various inventive aspects have been described herein above. Of course, it is to be understood that not necessarily all such objects or advantages may be achieved in accordance with any particular embodiment of the disclosed techniques. Thus, for example, those skilled in the art will recognize that the disclosed techniques may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 illustrates a programmable computer system with which various embodiments of the disclosed technology may be employed.

FIG. 2 illustrates an example of a test compression analyzer that may be implemented according to various embodiments of the disclosed technology.

FIG. 3 illustrates a flowchart showing a process of machine-learning-based test coverage and data volume prediction that may be implemented according to various examples of the disclosed technology.

FIG. 4 illustrates an example of test architecture for a circuit design.

FIG. 5 illustrates an example of fault partition and profiling based on SCOAP scores which may be used as machine learning model input features according to some examples of the disclosed technology.

FIG. 6 illustrates an example of clock domain compatibility analysis which may be used as machine learning model input features according to some examples of the disclosed technology.

FIG. 7 illustrates an example of one or more machine learning models that can be may be implemented according to various examples of the disclosed technology.

FIG. 8 illustrates an example of using two separate machine learning models for predicting test coverage and test data volume, respectively that can be may be implemented according to various examples of the disclosed technology.

FIG. 9 illustrates an example of a deep neural network that may be employed by the one or more machine learning models according to various examples of the disclosed technology.

### DETAILED DESCRIPTION OF THE DISCLOSED TECHNIQUES

### General Considerations

Various aspects of the disclosed technology relate to machine-learning-based test coverage and data volume prediction for determining test configuration. In the following description, numerous details are set forth for the purpose of explanation. However, one of ordinary skill in the art will realize that the disclosed technology may be practiced without the use of these specific details. In other instances, well-known features have not been described in detail to avoid obscuring the disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods.

The detailed description of a method or a device sometimes uses terms like “perform,” “train,” and “analyze” to describe the disclosed method or the device function/structure. Such terms are high-level descriptions. The actual operations or functions/structures that correspond to these terms will vary depending on the particular implementation and are readily discernible by one of ordinary skill in the art.

Additionally, as used herein, the term “design” is intended to encompass data describing an entire integrated circuit device. This term also is intended to encompass a smaller group of data describing one or more components of an entire device such as a portion of an integrated circuit device nevertheless.

### Illustrative Operating Environment

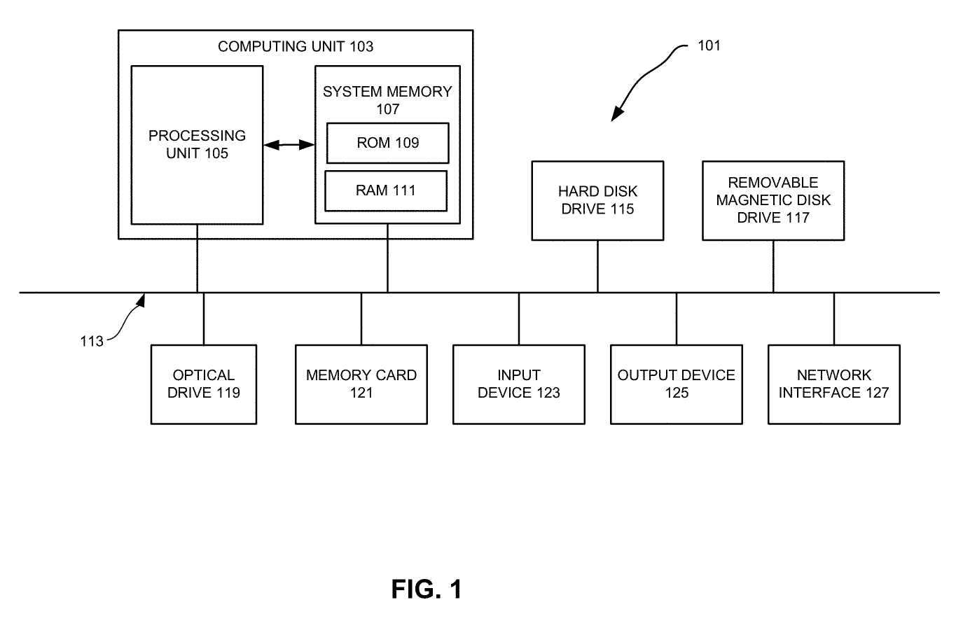

Various examples of the disclosed technology may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but it will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it is not intended to be limiting. Various embodiments of the disclosed technology may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the disclosed technology may be implemented using a multi-processor computer, a plurality of single and/or multiprocessor computers arranged into a network, or some combination of both.

### Design For Test, Test Pattern Generation, and Testing

The reduction in feature size increases the probability that a manufacture defect in the integrated circuit will result in a faulty chip. A very small defect can result in a faulty transistor or interconnecting wire. Even a single faulty transistor or wire can cause the entire chip to function improperly. Manufacture defects are unavoidable nonetheless, no matter whether the manufacturing process is at the prototype stage or the high-volume manufacturing stage. It is thus necessary to test chips during the manufacturing process. Diagnosing faulty chips is also needed to ramp up and to maintain the manufacturing yield.

Testing typically includes applying a set of test stimuli (test patterns) to the circuit-under-test and then analyzing responses generated by the circuit-under-test. Functional testing attempts to validate that the circuit-under-test operates according to its functional specification while structural testing tries to ascertain that the circuit-under-test has been assembled correctly from some low-level building blocks as specified in a structural netlist and that these low-level building blocks and their wiring connections have been manufactured without defect. For structural testing, it is assumed that if functional verification has shown the correctness of the netlist and structural testing has confirmed the correct assembly of the structural circuit elements, then the circuit should function correctly. Structural testing has been widely adopted at least in part because it enables the test (test pattern) generation to focus on testing a limited number of relatively simple circuit elements rather than having to deal with an exponentially exploding multiplicity of functional states and state transitions.

To make it easier to develop and apply test patterns, certain testability features are added to circuit designs, which is referred to as design for test or design for testability (DFT). Scan testing is the most common DFT method. In a basic scan testing scheme, all or most of internal sequential state elements (latches, flip-flops, et al.) in a circuit design are made controllable and observable via a serial interface. These functional state elements are usually replaced with dual-purpose state elements called scan cells. Scan cells are connected together to form scan chains—serial shift registers for shifting in test patterns and shifting out test responses. A scan cell can operate as originally intended for functional purposes (functional/mission mode) and as a unit in a scan chain for scan (scan mode). A widely used type of scan cell include an edge-trigged flip-flop with two-way multiplexer for the data input. The two-way multiplexer is typically controlled by a single control signal called scan_enable, which selects the input signal for a scan cell from either a scan signal input port or a system signal input port. The scan signal input port is typically connected to an output of another scan cell while the system signal input port is connected to the functional logic. Scan cells can serve as both a control point and an observation point. Control points can be used to set certain logic values at some locations of the circuit-under-test, exciting (activating) a fault and propagating the incorrect value to an observation point. Scan testing allows the test equipment to access gates deeply embedded through the primary inputs/outputs and/or some physical test points and can remove the need for complicated state transition sequences when trying to control or observe what is happening at some internal circuit element.

Test patterns for scan testing are typically generated through an automatic test pattern generation (ATPG) process. ATPG usually focuses on a set of faults derived from a gate-level fault model. A defect is a flaw or physical imperfection caused in a device during the manufacturing process. A fault model (or briefly a fault) is a description of how a defect alters design behavior. For a given target fault, ATPG comprises two phases: fault activation and fault propagation. Fault activation establishes a signal value at the fault site opposite that produced by the fault. Fault propagation propagates the fault effect forward by sensitizing a path from a fault site to a scan cell or a primary output. A fault at a site is said to be detected by a test pattern if a test response value captured by a scan cell or a primary output is different than the expected value. The objective of ATPG is to find a test pattern that, when applied to the circuit, enables testers to distinguish between the correct circuit behavior and the faulty circuit behavior caused by one or more particular faults. Effectiveness of ATPG is measured by the fault coverage achieved for the fault model and the number of generated vectors (test pattern counts), which should be directly proportional to test application time. Here, the fault coverage is defined as a ratio of the number of detected faults vs. the total number of faults.

The most popular fault model used in practice is the single stuck-at fault model. In this model, one of the signal lines in a circuit is assumed to be stuck at a fixed logic value, regardless of what inputs are supplied to the circuit. The stuck-at fault model is a logical fault model because no delay information is associated with the fault definition. Delay faults cause errors in the functioning of a circuit based on its timing. They are caused by the finite rise and fall time periods of the signals in the gates, as well as, the propagation delay of interconnects between the gates. Transition faults are used for their simplicity in modeling spot defects that affect delays at inputs or outputs of gates. Under scan-based tests, the transition faults are associated with an extra delay that is large enough to cause the delay of any path through the fault site to exceed the clock period. Cell internal fault models can be derived using transistor-level circuit simulations (analog simulations). This approach can pinpoint the defect location within a cell for various cell internal defects.

During the circuit design and manufacturing process, a manufacturing test screens out chips (dies) containing defects. The test itself, however, does not identify the reason for the unacceptable low or fluctuating yield that may be observed. Physical failure analysis (PFA) can inspect the faulty chip to locate the defect location(s) and to discover the root cause. The process usually includes etching away certain layers and then imaging the silicon surface by scanning electronic microscopy or focused ion beam systems. This PFA process is laborious and time consuming. To facilitate the PFA process, diagnosis (also referred to as scan diagnosis) is often employed to narrow down possible locations of the defect(s) based on analyzing the fail log (fail file, failure file). The fail log typically contains information about when (e.g., tester cycle), where (e.g., at what tester channel), and how (e.g., at what logic value) the test failed and which test patterns generate expected test responses. The layout information of the circuit design may also be employed to further reduce the number of defect suspects.

Test application in chip manufacturing test is normally performed by automatic test equipment (ATE) (a type of testers). Scan-based tests consume significant amounts of storage and test time on ATE. The data volume increases with the number of logic gates on the chip and the same holds for the number of scan cells. Yet, practical considerations and ATE specifications often limit both the number of pins available for scan in/out and the maximum scan frequency. It is highly desirable to reduce the amount of test data that need to be loaded onto ATE and ultimately to the circuit under test. Fortunately, test patterns are compressible mainly because only 1% to 5% of test pattern bits are typically specified bits (care bits) while the rest are unspecified bits (don't-care bits). Unspecified bits can take on any values with no impact on the fault coverage. Test compression may also take advantage of the fact that test cubes tend to be highly correlated. A test cube is a deterministic test pattern in which the don't-care bits are not filled by ATPG. The correlation exists because faults are structurally related in the circuit.

Various test compression techniques have been developed. In general, additional on-chip hardware before and after scan chains is inserted. The hardware (decompressor) added before scan chains is configured to decompress test stimulus coming from ATE, while the hardware (compactor) added after scan chains is configured to compact test responses captured by the scan chains. The decompressor expands the data from n tester channels to fill greater than n scan chains. The increase in the number of scan chains shortens each scan chain and thus reduces the number of clock cycles needed to shift in each test pattern. Thus, test compression can not only reduce the amount of data stored on the tester but also reduce the test time for a given test data bandwidth.

The embedded deterministic test (EDT) is one example of test compression techniques. The EDT-based compression is composed of two complementary parts: hardware that is embedded on chip, and deterministic ATPG software that generates compressed patterns that utilize the embedded hardware. The EDT hardware features a continuous-flow decompressor. The EDT compression of test cubes is performed by treating the external test data as Boolean variables. Scan cells are conceptually filled with symbolic expressions that are linear functions of input variables injected into the decompressor. In the case of a decompressor comprising a ring generator and an associated phase shifter, a set of linear equations corresponding to scan cells whose values are specified may be used. A compressed pattern can be determined by solving the system of equations. If the compressed pattern determined as such is then scanned in through the decompressor, the bits that were specified by ATPG will be generated accordingly. Unspecified bits are set to pseudorandom values based on the decompressor architecture. Additional details concerning EDT-based compression and decompression are found in J. Rajski, J. Tyszer, M. Kassab, and N. Mukherjee, “Embedded deterministic test,” IEEE Trans. CAD, vol. 23, pp. 776-792, May 2004, and U.S. Pat. Nos. 6,327,687; 6,353,842; 6,539,409; 6,543,020; 6,557,129; 6,684,358; 6,708,192; 6,829,740; 6,874,109; 7,093,175; 7,111,209; 7,260,591; 7,263,641; 7,478,296; 7,493,540; 7,500,163; 7,506,232; 7,509,546; 7,523,372; 7,653,851, of which all are hereby incorporated herein by reference.

Logic built-in self-test (logic BIST) is a DFT technique that permits a circuit to test itself using embedded test logic without the need of an external tester. Classical logic BIST applications include detecting infant mortality defects during burn-in test, enabling the use of low-cost and/or low-speed testers that only provide power and clock signals, and in-system self-testing to improve the reliability of the system in aerospace/defense, automotive, telecommunications and healthcare industries. A typical logic BIST system includes a test pattern generator for automatically generating test patterns, a test response analyzer (compactor) for compacting test responses into a signature and a logic BIST controller for coordinating the BIST operation and for providing a pass/fail indication. A pseudo-random pattern generator (PRPG), a commonly used test pattern generator, can be constructed from a linear feedback shift register (LFSR) or a cellular automaton. To increase the fault coverage, a weighted LFSR may be employed. Another approach is to combine random test patterns with deterministic patterns in some fashion as the BIST logic can be used to handle compressed test patterns that are generated deterministically and stored on chip.

All of the above mentioned processes, design insertion for testing, test pattern generation, and logic diagnosis, are normally performed by various electronic design automation tools such as those in the Tessent family of software tools available from Mentor Graphics Corporation, Wilsonville, Oreg.

### Test Compression Analyzer

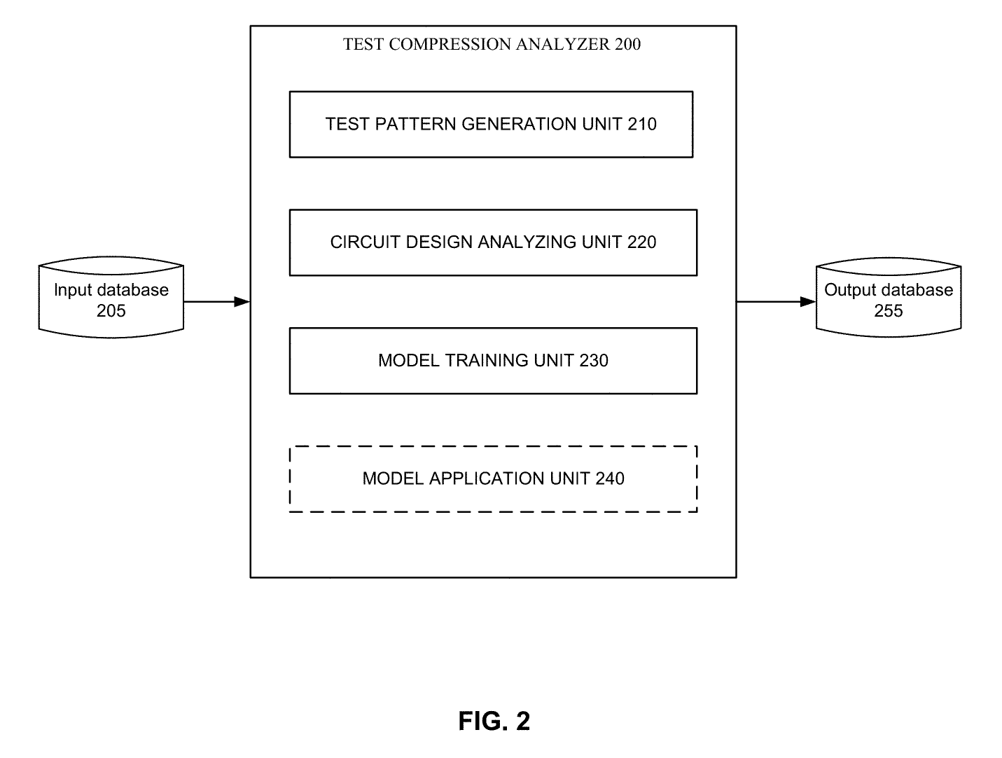

FIG. 2 illustrates an example of a test compression analyzer 200 that may be implemented according to various embodiments of the disclosed technology. As seen in this figure, the test compression analyzer 200 includes a test pattern generation unit 210, a circuit design analyzing unit 220, and a model training unit 230. Some implementations of the test pattern generation tool 200 may cooperate with (or incorporate) one or more of a model application unit 240, an input database 205 and an output database 255.

As will be discussed in more detail below, the test compression analyzer 200 receives, from the input database 205, a plurality of circuit designs and a plurality sets of values of test configuration features for each of the plurality of circuit designs. The test configuration features comprises numbers for scan chains, input channels for decompressors and output channels for compactors, respectively. The test pattern generation unit 210 performs test pattern generation to determine values of test coverage and values of test data volume for each of the plurality sets of values of the test configuration features and for each of the plurality of circuit designs. The circuit design analyzing unit 220 analyzes the plurality of circuit designs to determine values of design complexity features for each of the plurality of circuit designs. The model training unit 230 trains one or more machine-learning models based on the plurality sets of test configuration feature values, the values of design complexity features, the values of test coverage, and the values of test data volume. Here, input features for the one or more machine-learning models comprise the test configuration features and the design complexity features, and output features for the one or more machine-learning models comprise the test coverage and the test data volume. The model application unit 240 can use the one or more machine-learning models to predict values of the test coverage and values of the test data volume for a plurality sets of values of the test configuration features for a new circuit design, and determines optimal values of the test configuration features for the new circuit design. The generated one or more machine-learning models may be stored in the output database 255.

As previously noted, various examples of the disclosed technology may be implemented by one or more computing systems, such as the computing system illustrated in FIG. 1. Accordingly, one or more of the test pattern generation unit 210, the circuit design analyzing unit 220, the model training unit 230 and the model application unit 240 may be implemented by executing programming instructions on one or more processors in one or more computing systems, such as the computing system illustrated in FIG. 1. Correspondingly, some other embodiments of the disclosed technology may be implemented by software instructions, stored on a non-transitory computer-readable medium, for instructing one or more programmable computers/computer systems to perform the functions of one or more of the test pattern generation unit 210, the circuit design analyzing unit 220, the model training unit 230 and the model application unit 240. As used herein, the term “non-transitory computer-readable medium” refers to computer-readable medium that are capable of storing data for future retrieval, and not propagating electro-magnetic waves. The non-transitory computer-readable medium may be, for example, a magnetic storage device, an optical storage device, or a solid state storage device.

It also should be appreciated that, while the test pattern generation unit 210, the circuit design analyzing unit 220, the model training unit 230 and the model application unit 240 are shown as separate units in FIG. 2, a single computer (or a single processor within a master computer) or a single computer system may be used to implement some or all of these units at different times, or components of these units at different times.

With various examples of the disclosed technology, the input database 205 and the output database 255 may be implemented using any suitable computer readable storage device. That is, either of the input database 205 and the output database 255 may be implemented using any combination of computer readable storage devices including, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable storage devices may also include magnetic cassettes, magnetic tapes, magnetic disks or other magnetic storage devices, holographic storage devices, or any other non-transitory storage medium that can be used to store desired information. While the input database 205 and the output database 255 are shown as separate units in FIG. 2, a single data storage medium may be used to implement some or all of these databases.

### Test Configuration Feature Determination

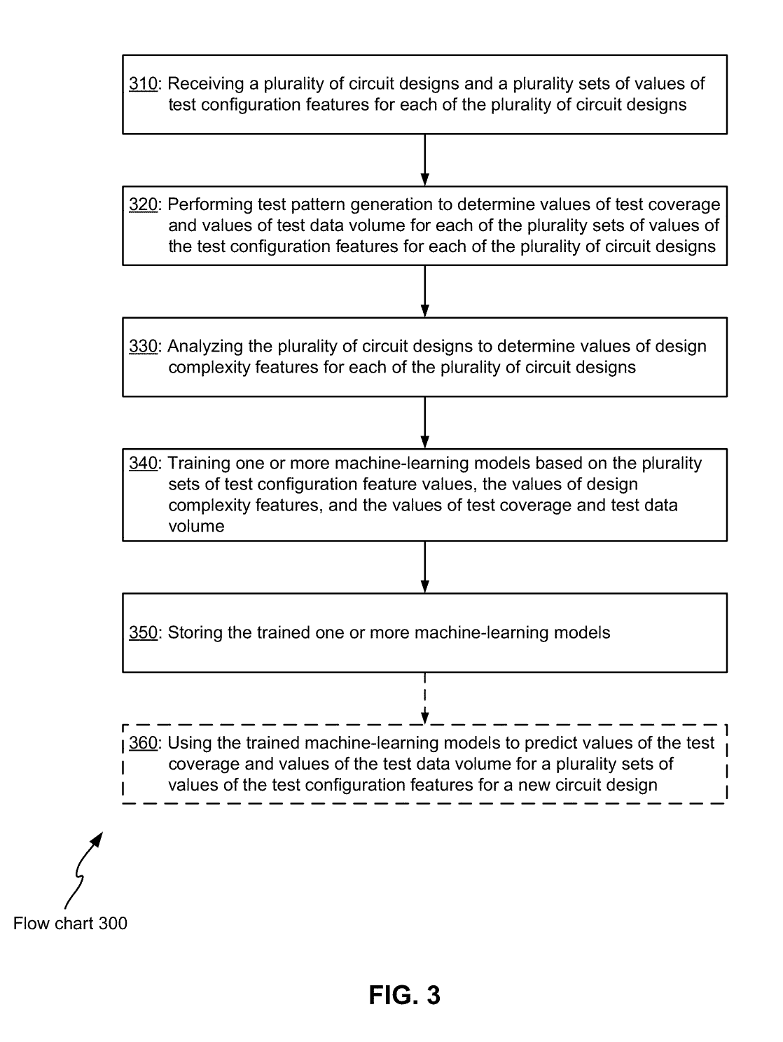

FIG. 3 illustrates a flowchart 300 showing a process of machine-learning-based test coverage and data volume prediction that may be implemented according to various examples of the disclosed technology. For ease of understanding, methods of machine-learning-based test coverage and data volume prediction that may be employed according to various embodiments of the disclosed technology will be described with reference to the test compression analyzer 200 in FIG. 2 and the flow chart 300 illustrated in FIG. 3. It should be appreciated, however, that alternate implementations of a test compression analyzer may be used to perform the methods of machine-learning-based test coverage and data volume prediction illustrated by the flow chart 300 according to various embodiments of the disclosed technology. Likewise, the test compression analyzer 200 may be employed to perform other methods of machine-learning-based test coverage and data volume prediction according to various embodiments of the disclosed technology.

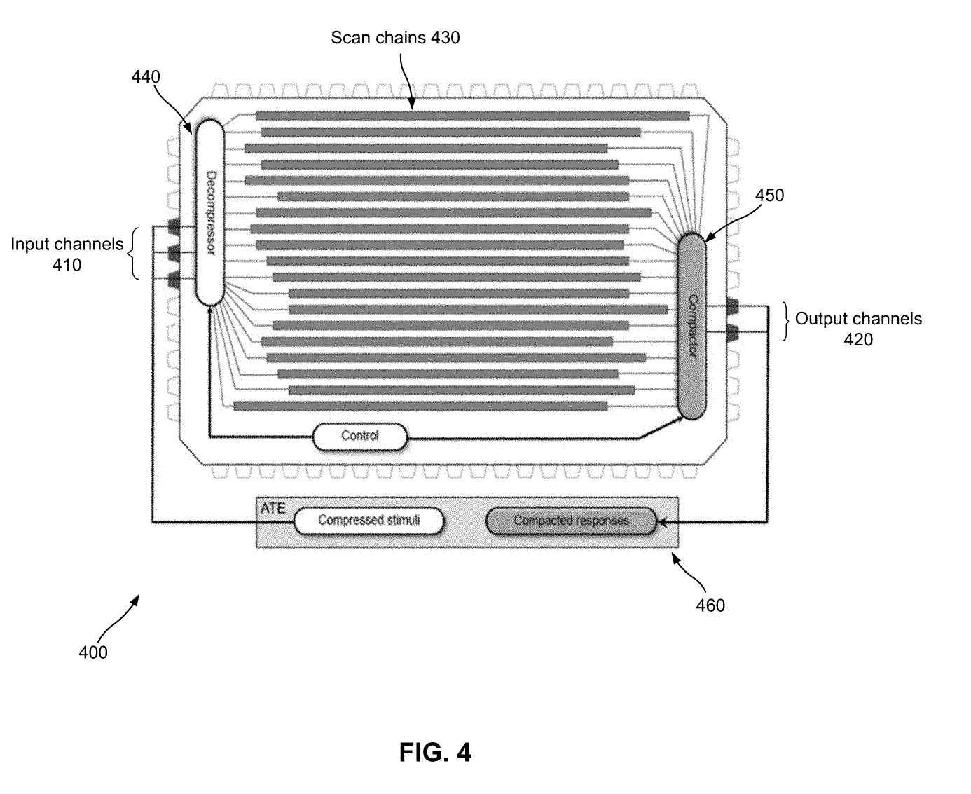

In operation 310, the test compression analyzer 200 receives a plurality of circuit designs and a plurality sets of values of test configuration features for each of the plurality of circuit designs from the input database 205. The test configuration features comprise numbers for scan chains, input channels for decompressors and output channels for compactors, respectively. The test configuration features may further comprise the number of decompressor modular units such as EDT blocks if a design has multiple units and/or low power threshold values. FIG. 4 illustrates an example of test architecture for a circuit design. The test architecture 400 has three input scan channels 410, many short internal scan chains 430, and two output scan channels 420. From the point of view of a tester 460, however, the design appears to have three short scan chains at the input. In every clock cycle, 3 bits of stimuli are applied to inputs of a decompressor 440 (one bit on each input channel), while outputs of the decompressor 440 load the scan chains 430. At the output, the design appears to have two short scan chains. In every clock cycle, test responses captured by the scan chains 430 at the same cycle are compacted through a compactor 450 and 2 bits of outputs of the compactor 450 are collected at the tester 460 (one bit on each output channel).

For each of the plurality of circuit designs, the test architecture can have different combinations of the values of test configuration features. For example, eight industrial circuit designs are used to demonstrate the disclosed technology. Each of the eight industrial circuit designs can have 250 sets of values of test configuration features by choosing the values of test configuration features from the following: 1) number of scan chains=140, 270, 400, 530, 660, 790, 920, 1050, 1180 and 1310; 2) number of input channels=1, 3, 5, 7 and 9; and 3) number of output channels=1, 3, 5, 7 and 9. The total number of machine-learning training cases is 250×8=2000.

In operation 320, the test pattern generation unit 210 performs test pattern generation to determine values of test coverage and values of test data volume for each of the plurality sets of values of the test configuration features for each of the plurality of circuit designs. The test pattern generation unit 210 may be implemented with a commercially available ATPG tool such as those in the Tessent family of software tools available from Mentor Graphics Corporation, Wilsonville, Oreg. The test data volume can be associated with the number of generated test patterns, and the test coverage can be associated by a percentage value of faults detectable by the generated test patterns vs. targeted faults.

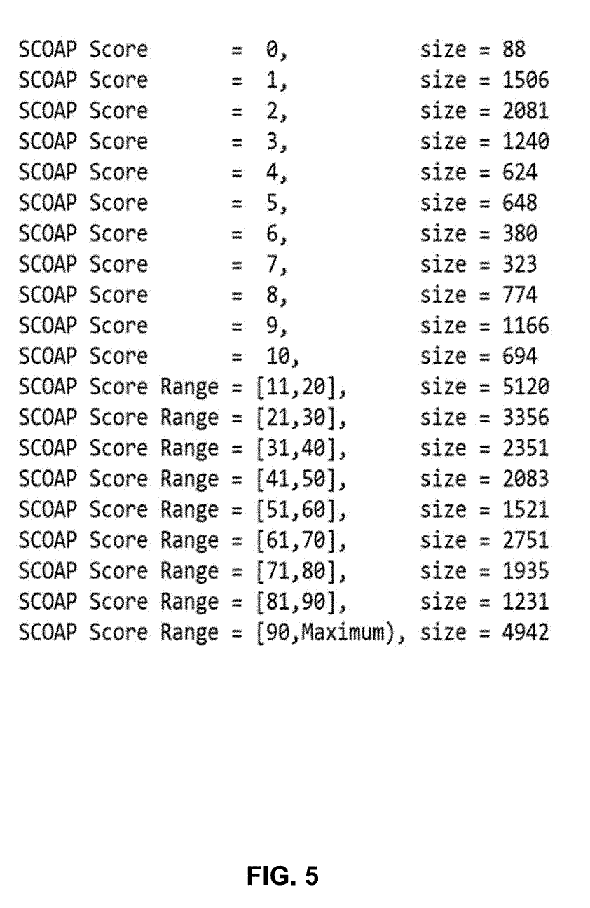

In operation 330, the circuit design analyzing unit 220 analyzes the plurality of circuit designs to determine values of design complexity features for each of the plurality of circuit designs. The design complexity features may comprise testability, X-profiling, clock domains, power domains, design-rule-checking warnings, or any combination thereof. The testability of a fault may be calculated as the sum of its controllability and observability scores. The controllability can be defined as the difficulty of setting a particular logic signal to a 0 or a 1. Output 1 values for AND gates are more expensive than OR gates. The observability can be defined as the difficulty of observing the state of a logic signal. Various algorithms can be employed to determine the testability. The Sandia controllability observability analysis program (SCOAP) is one example. The generated testability scores can be used to partition the faults into multiple bins. An example of fault partition and profiling is shown in FIG. 5. The size in the figure is the number of faults that have the exact corresponding SCOAP score or their SCOAP scores falling into the corresponding range. For example, there are 1,240 faults with SCOAP score of 3 and there are 2,083 faults with SCOAP scores between 41 and 50. The size of each individual bin can be used as input features to machine learning models. The granularity of partition can be user defined. In general, the finer partition, the more accurate feature it can extract, but with higher cost due to more input features.

In scan-based digital circuits, some values captured by scan cells are unknown values (not predictable) due to various factors including embedded memories, uninitialized scan cells, analog circuits, false/multi-cycle paths, et al. The number and distribution of unknowns (“X”s) are an important parameter for determining the compaction ratio at the output side. If the percentage of captured Xs is too high, it will impact pattern count because X-masking patterns will be generated, which increases the total pattern count. In EDT, the so-called “Xpress compactor”optimizes compression for all designs but is especially effective for designs that generate X values. The Xpress compactor observes all chains with known values and masks out scan chains that contain X values. An ATPG without any compactor may be performed. For each pattern, the number of “X”s captured into scan cells can be counted. Then the test patterns can be partitioned into multiple bins each bin has for example 0%-1% “X”s, 1%-2% “X”s . . . . The size of each bin can be used as input features for machine learning models.

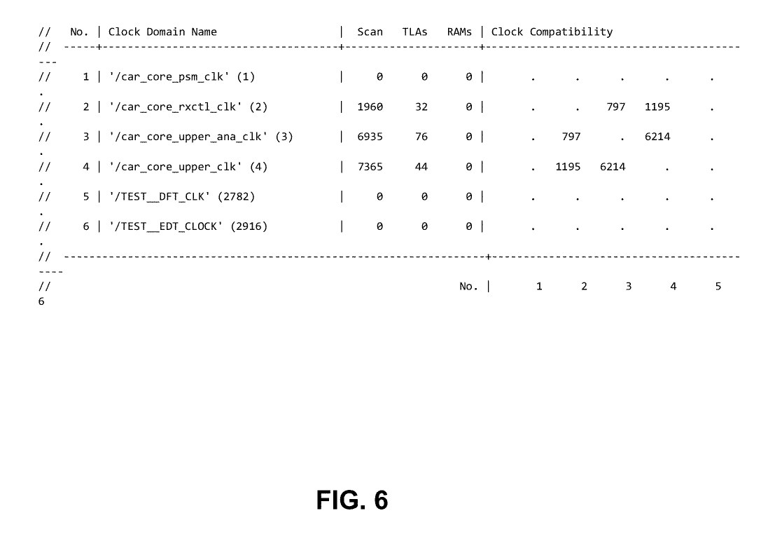

Almost all modern designs have multiple clock domains. Some clock domains are compatible, which means theses clocks can be clocked simultaneously within scan capture cycles. Incompatible clocks are not allowed to pulse between load/unload operations. So the clock domains and their compatibility will significantly impact test coverage and pattern count. An example of clock domain compatibility analysis is illustrated in FIG. 6. This design has 6 clock domains. In the figure. “.” represents no incompatible clock pair, and the number indicated the number of incompatible clock pairs. This or some other forms may serve as one of the input features for machine learning models.

In addition, modern designs typically have multiple power domains. ATPG generates patterns only for the current power mode. If there are different power modes which enable the identical power domains (just in different voltage configuration), then the pattern set can be reused by loading the pattern file and performing fault grading. Similar to the compatibility analysis of clock domains, compatibility analysis for power domains can be performed and used as input features of machine learning models.

Design Rule Checking (DRC) are extensively used in scan-insertion, ATPG, pattern retargeting etc. It can check the potential loss of test coverage and/or pattern inflation. DRC rules include, but not limited to the following categories: RAM Rules, Assertion Rules, BIST Rules Clock Rules, Scan Cell Data Rules, Pre-DFT Clock Rules, EDT Finder Rules, Flattening Rules, ICL Extraction Rules, EDT Rules, Test Procedure Rules, Core Mapping for ATPG and Scan Pattern Retargeting Rules, Scannability Rules, Scan Chain Trace Rules, Power-Aware Rules and Timing Rules. Different violations of rules have different impacts. Penalty scores may be assigned to violations of DRC rules or violation warnings based on their severity and violation times. These penalty scores may be used as input features of machine learning models.

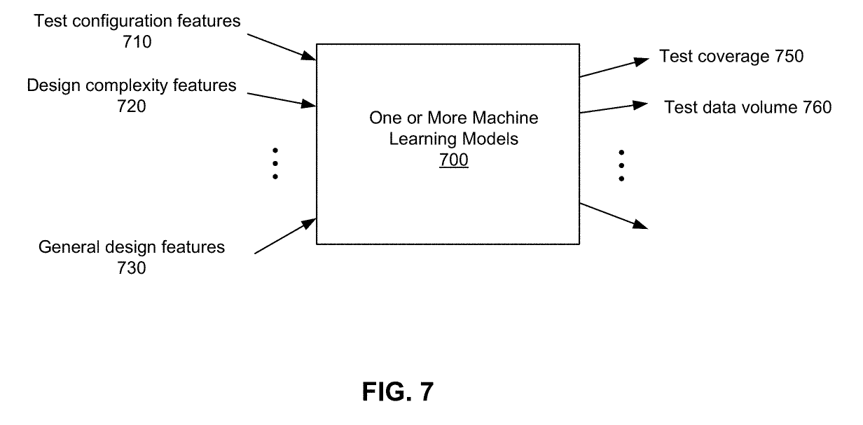

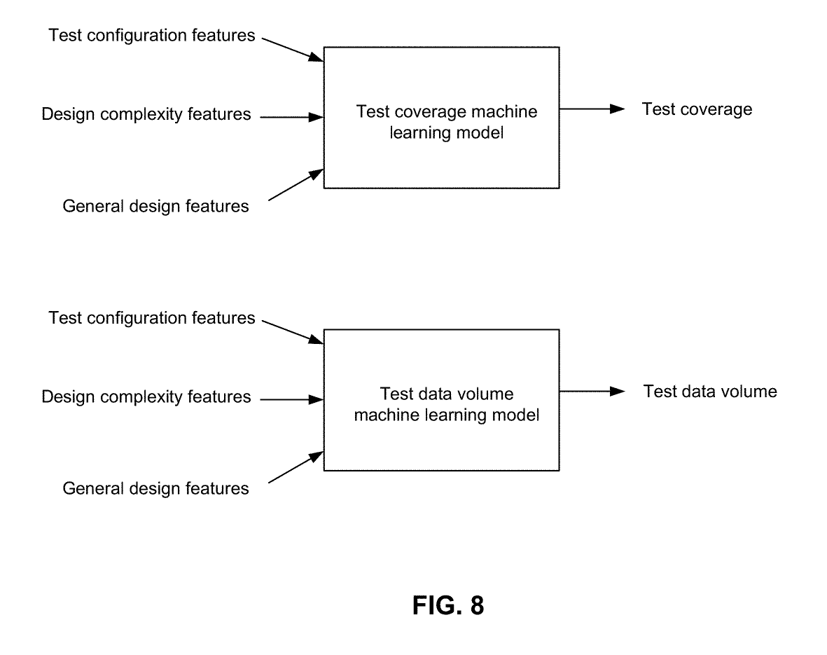

Refer back to the flowchart 300. In operation 340, the model training unit 230 trains one or more machine-learning models based on the plurality sets of test configuration feature values, the values of design complexity features, the values of test coverage, and the values of test data volume. FIG. 7 illustrates an example of one or more machine learning models 700 that can be may be implemented according to various examples of the disclosed technology. The one or more machine learning models 700 has input features comprising the test configuration features and the design complexity features. The input features may further comprise general design features which may comprise a number of gates, a number of faults, a number of primary inputs, a number of primary outputs, or any combination thereof. The one or more machine learning models 700 may be just one machine learning model. Alternatively, the one or more machine learning models 700 may be two machine learning models as illustrated by FIG. 8: both can have the same input features, but one has the test coverage as the output feature while the other has test data volume as the output feature. Using two separate models may have advantages of avoid intertwining of weights and biases which can impact the prediction accuracy.

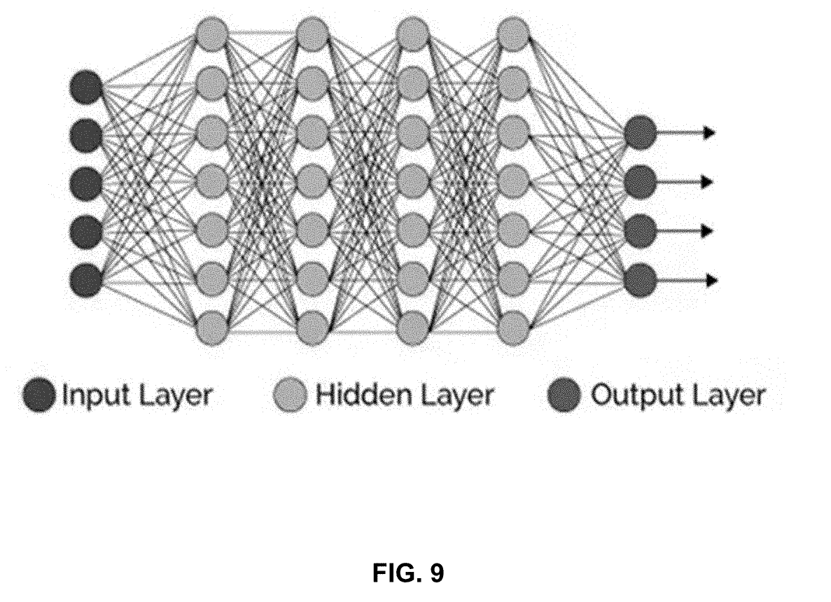

FIG. 9 illustrates an example of a deep neural network 800 that may be employed by the model training unit 230. The deep neural network 800 has one input layer, multiple hidden layers, and one output layer. In a fully-connected network, each neuron is connected to all of the neurons in its adjacent layer(s). In general, a neuron performs the computation in two steps: 1) a weighted sum of the values it receives from the previous layer, using the weights of the associated connections, and 2) a nonlinear activation function applied to the weighted sum. Assume that the input to layer i is a vector X. The weights of layer i are the elements of a matrix Wᵢ with the number of its rows equal to the dimension of the layer's input X and the number of its columns equals the number of neurons in this layer. Also there is a bias vector bᵢ. The output of the layer i of the neural network is Oᵢ(X)=X•Wᵢ+bᵢ, where • is the dot product operator between matrices. The activation function then acts on each element in the output vector and the resulting vector acts as an input to the next layer. The above-mentioned procedure is iteratively executed for each layer until the data reach the output layer. This procedure is called forward propagation. A learning algorithm is to find the optimal weights and biases. The most popular type of learning algorithms is called supervised learning, in which many training data with their known outputs (called labels) are used to train the DNN in a way that the predicted output of each training data at a neural network is as close to the corresponding labels as possible. This is done by an algorithm called backpropagation, which calculates the weights and biases to minimize the prediction error. After the training, if the weights and biases have converged, these parameters are determined. One can then use the forward propagation to predict the output for any test data that were not seen before in the training data.

In operation 350, the test compression analyzer 200 stores the trained one or more machine-learning models in the output database 255.

Optionally, in operation 360, the model application unit 240 uses the trained one or more machine-learning models to predict values of the test coverage and values of the test data volume for a plurality sets of values of the test configuration features for a new circuit design. The model application unit 240 can then analyze the predicted values of the test coverage and the predicted values of the test data volume to determine optimal values of the test configuration features for the new circuit design. The criteria may be to reach the highest test coverage with minimum data volume. The disclosed technology can estimate test coverage and test data volume without performing time-consuming test pattern generation.

### Conclusion

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the disclosed technology. Rather, the scope of the disclosed technology is defined by the following claims and their equivalents. We therefore claim as our disclosed technology all that comes within the scope and spirit of these claims.

What is claimed is:

1. A method, executed by at least one processor of a computer, comprising:
receiving a plurality of circuit designs and a plurality sets of values of test configuration features for each of the plurality of circuit designs, the test configuration features comprising numbers for scan chains, input channels for decompressors and output channels for compactors, respectively;
performing test pattern generation to determine values of test coverage and values of test data volume for each of the plurality sets of values of the test configuration features for each of the plurality of circuit designs;
analyzing the plurality of circuit designs to determine values of design complexity features for each of the plurality of circuit designs;
training one or more machine-learning models based on the plurality sets of test configuration feature values, the values of design complexity features, the values of test coverage, and the values of test data volume, wherein input features for the one or more machine-learning models comprise the test configuration features and the design complexity features, and wherein output features for the one or more machine-learning models comprise the test coverage and the test data volume; and
storing the one or more machine-learning models.

2. The method recited in claim 1, further comprising:
using the one or more machine-learning models to predict values of the test coverage and values of the test data volume for a plurality sets of values of the test configuration features for a new circuit design; and
determining optimal values of the test configuration features for the new circuit design.

3. The method recited in claim 2, further comprising:
inserting test circuitry into the new circuit design based on the optimal values of the test configuration features.

4. The method recited in claim 1, wherein the input features for the one or more machine-learning models further comprises: one or more general design features.

5. The method recited in claim 4, wherein the one or more general design features comprises a number of gates, a number of faults, a number of primary inputs, a number of primary outputs, or any combination thereof.

6. The method recited in claim 1, wherein the one or more machine-learning models comprise a first machine-learning model and a second machine-learning model, the input features for the first machine-learning model and the input features for the second machine-learning model being the same, the output feature for the first machine-learning model being the test coverage, and the output feature for the second machine-learning model being the test data volume.

7. The method recited in claim 1, wherein the decompressors are EDT-based.

8. The method recited in claim 1, wherein the one or more machine-learning models are Artificial Neural Networks.

9. The method recited in claim 1, wherein the design complexity features comprise testability, X-profiling, clock domains, power domains, design-rule-checking warnings, or any combination thereof.

10. One or more non-transitory computer-readable media storing computer-executable instructions for causing one or more processors to perform a method, the method comprising:
receiving a plurality of circuit designs and a plurality sets of values of test configuration features for each of the plurality of circuit designs, the test configuration features comprising numbers for scan chains, input channels for decompressors and output channels for compactors, respectively;
performing test pattern generation to determine values of test coverage and values of test data volume for each of the plurality sets of values of the test configuration features for each of the plurality of circuit designs;
analyzing the plurality of circuit designs to determine values of design complexity features for each of the plurality of circuit designs;
training one or more machine-learning models based on the plurality sets of test configuration feature values, the values of design complexity features, the values of test coverage, and the values of test data volume, wherein input features for the one or more machine-learning models comprise the test configuration features and the design complexity features, and wherein output features for the one or more machine-learning models comprise the test coverage and the test data volume; and
storing the one or more machine-learning models.

11. The one or more non-transitory computer-readable media recited in claim 10, wherein the method further comprises:
using the one or more machine-learning models to predict values of the test coverage and values of the test data volume for a plurality sets of values of the test configuration features for a new circuit design; and
determining optimal values of the test configuration features for the new circuit design.

12. The one or more non-transitory computer-readable media recited in claim 11, wherein the method further comprises:
inserting test circuitry into the new circuit design based on the optimal values of the test configuration features.

13. The one or more non-transitory computer-readable media recited in claim 10, wherein the input features for the one or more machine-learning models further comprises: one or more general design features.

14. The one or more non-transitory computer-readable media recited in claim 13, wherein the one or more general design features comprises a number of gates, a number of faults, a number of primary inputs, a number of primary outputs, or any combination thereof.

15. The one or more non-transitory computer-readable media recited in claim 10, wherein the one or more machine-learning models comprise a first machine-learning model and a second machine-learning model, the input features for the first machine-learning model and the input features for the second machine-learning model being the same, the output feature for the first machine-learning model being the test coverage, and the output feature for the second machine-learning model being the test data volume.

16. The one or more non-transitory computer-readable media recited in claim 10, wherein the decompressors are EDT-based.

17. The one or more non-transitory computer-readable media recited in claim 10, wherein the one or more machine-learning models are Artificial Neural Networks.

18. The one or more non-transitory computer-readable media recited in claim 10, wherein the design complexity features comprise testability, X-profiling, clock domains, power domains, design-rule-checking warnings, or any combination thereof.
